(19) United States
(12) Patent Application Publication
(10) Pub. No.: US 2011/0117312 A1
(43) Pub. Date: May 19, 2011

(54) ANTI-SKIDDING STRUCTURE OF AUTOMOBILE FOOT MAT

(76) Inventor: Ming-Shun Yang, Taipei City (TW)

(21) Appl. No.: 12/618,770

(22) Filed: Nov. 15, 2009

(51) Int. Cl. B32B 33/00; D06C 11/00

(52) U.S. Cl. 428/91

(57) ABSTRACT

An anti-skidding structure is provided for an automobile foot mat, including an upper surface layer and an anti-skidding material bonded to a bottom. The surface layer can be made versatile by being formed of various substances, including a foaming substance, a carpet, thermoplastic elastomer, anti-skidding thermoplastic rubber, or polyvinylchloride to enhance the adaptability thereof. The bottom anti-skidding material includes a plurality of minute synthetic yarns. The layers are bonded together through application of adhesives or employing thermal fusion molding techniques. The structure provides an effect of touch-fastening to any type of carpet for resistance against relative skidding therebetween and does not cause any damage to the carpet when being separated. Thus, the foot mat is provided with excellent effect of anti-skidding and driving safety for automobiles in which the foot mat including the touch-fastening anti-skidding structure is placed can be improved.

### (a) TECHNICAL FIELD OF THE INVENTION

The present invention generally relates to an anti-skidding structure of automobile foot mat, which is particularly fit for anti-skidding purposes for floors made of felts/rugs, flannelette, and loop cloth, wherein the foot mat features touch-fastened anti-skidding without damage of the floor materials, so as to be suitable for automobile floor carpets or household carpets to be treaded as a foot mat and providing anti-skidding effect.

### (b) DESCRIPTION OF THE PRIOR ART

A conventional foot mat is often structured to form an anti-skidding structure on a bottom thereof so that when it is laid on a regular carpet to serve as a floor mat, it provides the effect of anti-skidding. For example, automobile floor carpets are generally divided as needle punched carpets and tufted carpets. To maintain and clean the in-car carpets, a removable foot mat is often provided to position on an in-car carpet that is often integrally formed with the automobile floor at a location where a driver or passengers may tread. Generally, the removable foot mats are arranged in a set composed of four mats, which are respectively positioned on the floors in front of the driver's seat, the front passenger's seat, and the back seat, in order to protect the expensive underside in-car carpet that is integrally formed in the automobile from being stained. A regular automobile foot mat is positioned on the in-car carpet, but relative sliding often occurs between the foot mat and the in-car carpet due to the force of treading applied by the automobile driver or passengers. This may become dangerous when undesired sliding occurs in the foot mat of the driver's seat, for such a sliding movement may bring the foot mat to such an undesired location where the mat hinders the operation of for example a brake pedal by reducing the stroke of the brake pedal. Improvement is certainly required for this problem.

Various anti-skidding structures of foot mats are known. For example, a foot mat is provided with a plurality of projecting spikes at an undersurface thereof so that when the foot mat is positioned on a carpet, the spikes penetrate into the material of the carpet to increase sliding resistance and friction therebetween thereby realizing anti-skidding. However, this type of anti-skidding structure formed of projecting spikes may easily cause damage to the surface of the carpet, and in addition, such type of anti-skidding structure does not provides good result of anti-skidding. Another known mat anti-skidding structure comprises hardened anti-skidding beads that are mode of non-woven fabric mounted to an undersurface of a mat. However, this type of anti-skidding structure only works for effecting anti-skidding on needle punched carpets, but does not work for tufted carpets. Thus, in the automobile industry, in order to realize effect anti-skidding between a foot mat and an in-car carpet, fixed positioning pillars are provided on the in-car carpet, while the foot mats form sockets at corresponding locations, whereby when the foot mat are correctly positioned, the sockets are fit over and engage the positioning pillars to securely fix the foot mats against undesired skidding. This arrangement, however, largely increases the manufacturing costs and is adverse for user replacing foot mats that may not be provided with sockets exactly corresponding to the existing positioning pillars, leading to very low chance of replacement of foot mat.

To solve the above problems, the present invention provides a unique touch-fastened anti-skidding structure to be attached to an undersurface of a foot mat. The anti-skidding material features easy processing in combining to both planar foot mats and three-dimensional foot mats. Further, the anti-skidding structure provided on the undersurface of the foot mat does not cause any damage or undesired napping on various materials, including felts/rugs, flannelette, and loop cloth and can be securely held in position without undesired skidding on the existing in-car carpets, thereby providing highly effectively effect of touch-fastened anti-skidding.

Thus, the present invention aims to provide an effective anti-skidding structure for an anti-skidding foot mat that is good for mass-production and has a light weight, excellent air-permeable and cushioning effect, and a simplified structure to realize anti-skidding for various materials, including felts/rugs, flannelette, and loop cloth.

### SUMMARY OF THE INVENTION

The primary objective of the present invention is to provide an anti-skidding structure of an automobile foot mat, which is suitable for various types of carpets, including needle punched carpets and tufted carpets, for increasing frictional force between an undersurface of the foot mat and an in-car carpet to realize anti-skidding.

Another objective of the present invention is to provide an anti-skidding structure of an automobile foot mat that does not cause damage or undesired napping of a carpet and possesses the advantages of simple structure, easy processability, low manufacturing cost, good durability, and excellent adaptability, and provides soft tactility for foot contact.

To achieve the above objectives, the present invention provides an anti-skidding structure of an automobile foot mat, which comprises an upper-layer, surface layer material and a lower-layer skidding-resistant anti-skidding material. The two layers are lapped and are bonded together through molding operation. The surface layer can be made of foaming substances, such as crosslinked polyethylene (XPE) foamed board, polyethylene (PE), ethylene-vinyl acetate copolymer (EVA), and polyurethane (PU) foamed board. The surface layer can be alternatively a carpet or a board made of thermoplastic elastomer (TPE), anti-skidding thermoplastic rubber (TPR), or polyvinylchloride (PVC). For a surface layer of the foot mat made of a foaming substance, a top layer may be further added atop the foaming substance and the top layer can be a carpet or a board made of TPE, anti-skidding TPR, or PVC to improve the feeling of product quality. The anti-skidding material of the lower layer comprises a plurality of minute synthetic yarns that can induce an effect of touch fastening and skidding resistance on any kinds of carpet and that can be separable from the carpets without causing any damage to the carpets, whereby the foot mat, as a whole, has high effect of anti-skidding.

The foot mat discussed above can be made as a planar mat, or it can be made in a three-dimensional configuration having a central recess surrounded by raised edge rims to facilitate subsequent cleaning operation of the automobile in which the foot mat is placed.

For an in-car foot mat, the following characteristics are required:

(1) A finished foot mat must be light in weight in order to meet the need for fuel saving and environmental protection.

(2) The foot mat must be effective in anti-skidding and does not cause any damage to the material of an in-car carpet.

(3) The manufacturing cost must be low and since improving market competitively by mass production will certainly lead to reduction of manufacturing costs, the improvement of manufacturing process and the selection of raw material must be exercised to both reduce sale price and enhance functionality.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an automobile foot mat in accordance with a first embodiment of the present invention.

FIG. 2 is a partial cross-sectional view of the automobile foot mat in accordance with the first embodiment of the present invention.

FIG. 3 is an exploded view of an automobile foot mat in accordance with a second embodiment of the present invention.

FIG. 4 is a partial cross-sectional view of the automobile foot mat in accordance with the second embodiment of the present invention.

FIG. 5 is a back side perspective view of an automobile foot mat constructed in accordance with the present invention.

FIG. 6 a back side perspective view of another automobile foot mat constructed in accordance with the present invention.

FIG. 7 is an enlarged view of a portion of a touch-fastening anti-skidding material in accordance with the present invention.

FIG. 8 is a schematic view showing a foundation layer and synthetic yarns woven together in accordance with the present invention.

FIG. 9 is a partial cross-sectional view of the touch-fastening anti-skidding material in accordance with the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

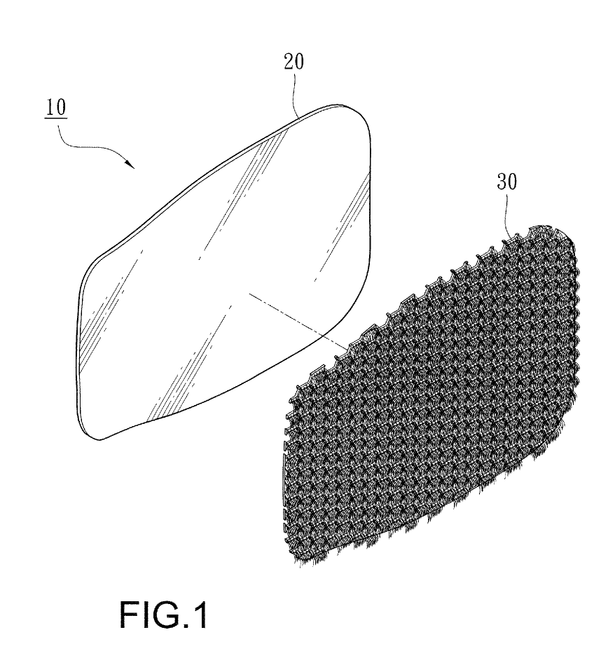

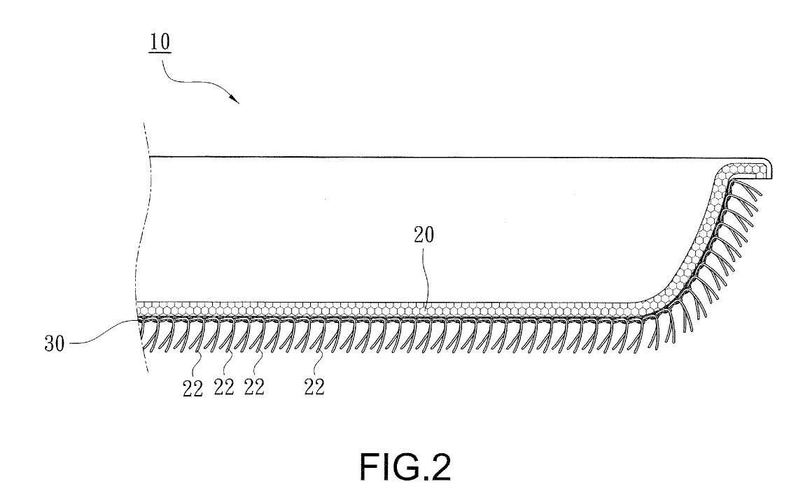

With reference to the drawings and in particular to FIGS. 1 and 2, the present invention provides a foot mat, generally designated at 10. The foot mat 10 is composed of a surface layer 20 that is located at the upper side and an anti-skidding layer 30 that is set at the bottom. The surface layer 20 can be solely made of a foaming substance, a carpet, thermoplastic elastomer (TPE), anti-skidding thermoplastic rubber (TPR), or polyvinylchloride (PVC). The layers are bonded together by applying adhesives or using thermal fusion molding techniques so that the mat so formed has an undersurface anti-skidding structure, which provides excellent resistance against undesired skidding when laid on a carpet and which also provides an advantage of reduction of manufacturing cost.

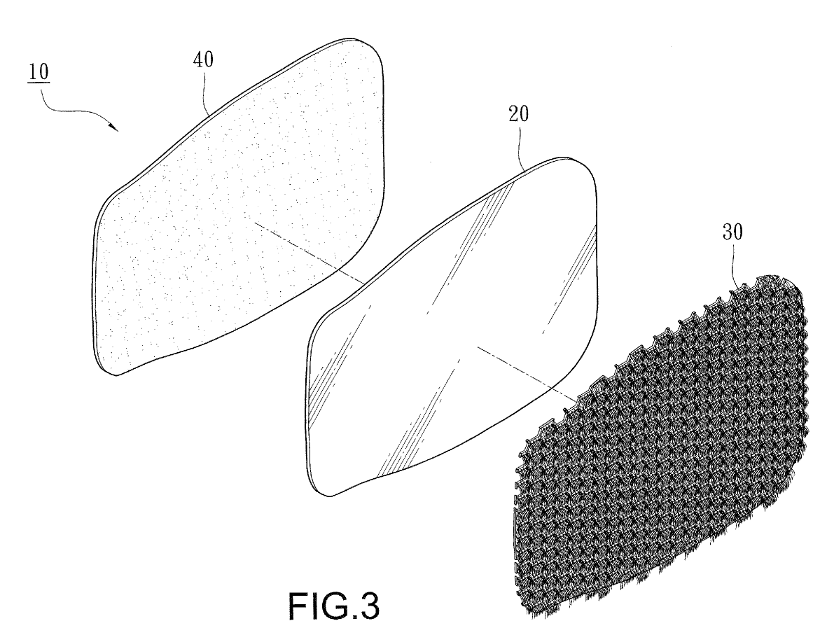

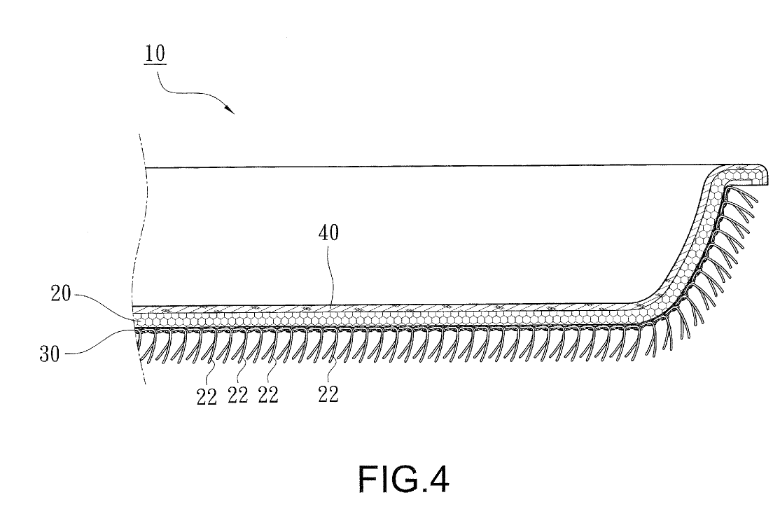

Referring to FIGS. 3 and 4, in another embodiment, besides the upper surface layer 20 and the bottom anti-skidding layer 30, the foot mat 10 further comprises a top layer 40 that is set atop the surface layer 20. The top layer can comprise a carpet or a board made of TPE, anti-skidding TPR, or PVC (see FIG. 3).

For a top layer 40 comprising a carpet, the carpet can be made of a material of polypropylene fibers or polyester fibers or a carpet made of a material of nylon fibers or PVC.

For a surface layer 20 made of a foaming substance, the foaming substance can be crosslinked polyethylene (XPE) foamed board, polyethylene (PE) foamed board, ethylene-vinyl acetate copolymer (EVA), and polyurethane (PU) foamed board. The foamed surface layer 20 shows the characteristics of sound isolation.

The surface layer 20 can be solely made of thermoplastic elastomer (TPE), anti-skidding thermoplastic rubber (TPR), or polyvinylchloride (PVC) with the anti-skidding layer 30 bonded to an underside thereof.

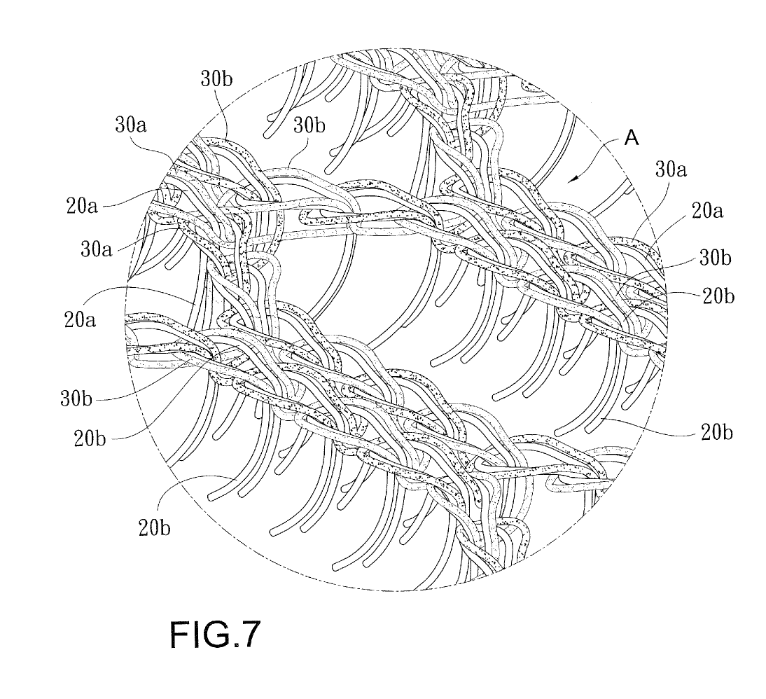

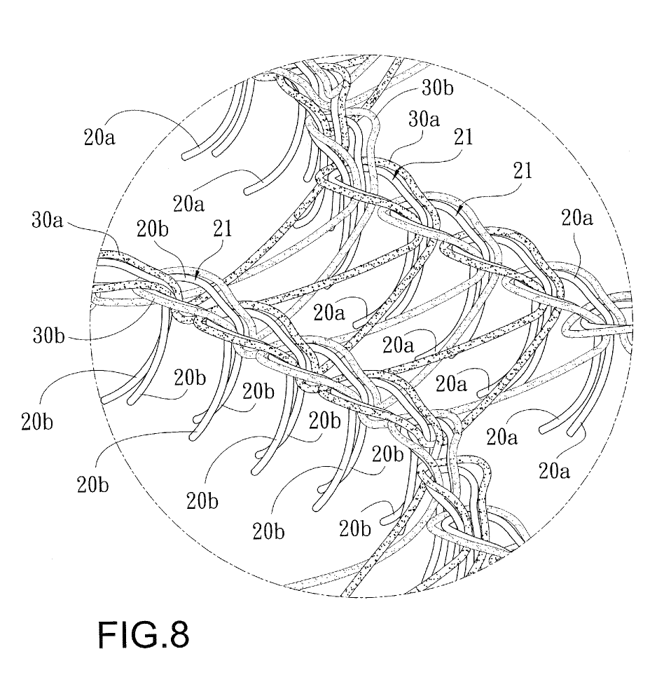

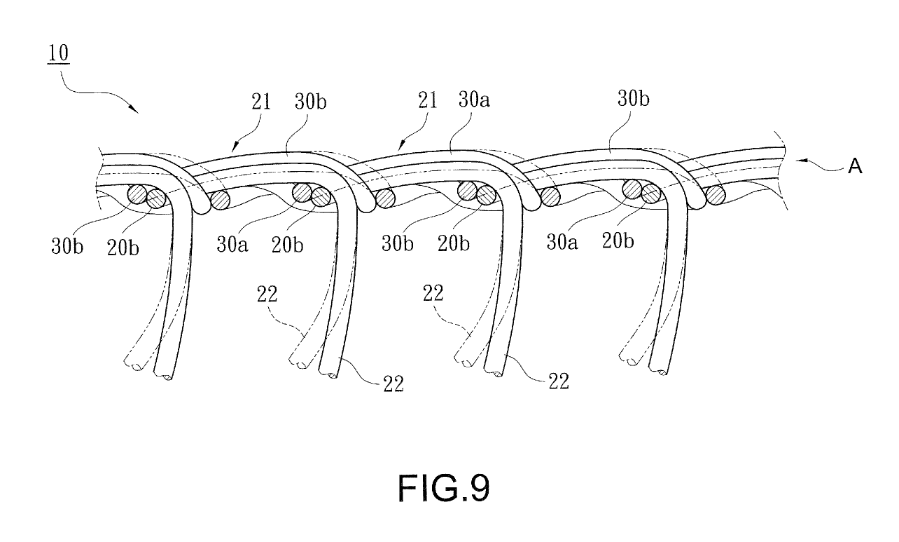

Reference is now made to FIGS. 7-9, in which FIG. 7 is a perspective view of a touch-fastening anti-skidding material in accordance with the present invention, FIG. 8 is an enlarged view of a portion of the touch-fastening anti-skidding material, and FIG. 9 is a schematic view showing a foundation layer and synthetic yarns woven together in accordance with the present invention. In the structure of the above discussed bottom anti-skidding layer 30, as shown, the touch-fastening anti-skidding material 10 in accordance with the present invention comprises a plurality of synthetic yarns 20a, 20b and pliable base yarns 30a, 30b. In preferred embodiment, each synthetic yarn 20a, 20b is bent to form a U-shaped configuration, having a loop 21 (see FIG. 8) and two outward-extending short legs 22 (see FIG. 9). Each rear loop 21 is set to loop around each front loop 21 so that the loops 21 are linked together with the short legs 22 that are located at ends of the loops 21 having a predetermined length extending outside a foundation layer A. The foundation layer A is formed by collectively weaving the synthetic yarns 20a, 20b and the base yarns 30a, 30b that respectively set on leftward and rightward locations, whereby the base yarns 30a, 30b are linked in a looping manner to a combination of the previous synthetic yarns and base yarns co-extensive with the synthetic yarns. In this way, a collectively woven, sound foundation layer A is formed. The synthetic yarns 20a, 20b can be made of nylon plastics, polyester fibers, polypropylene (PP) plastics, or polyethylene (PE) plastics.

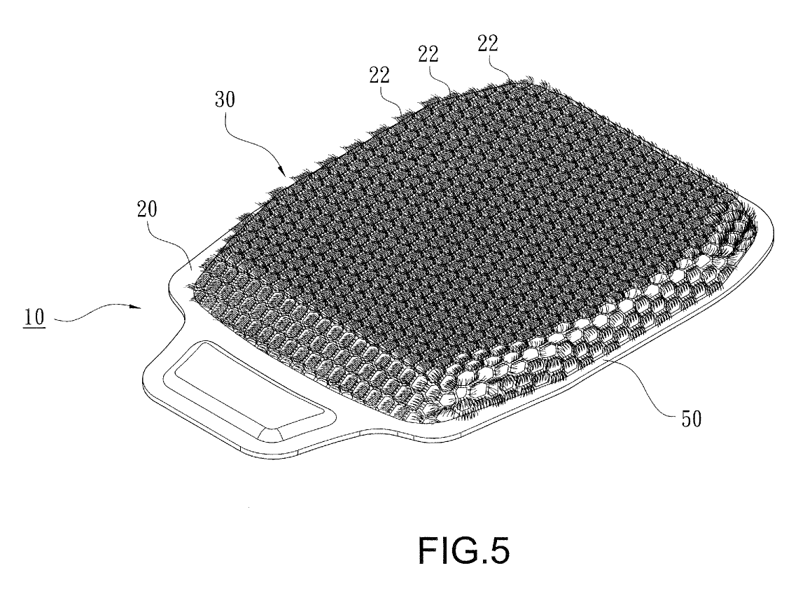

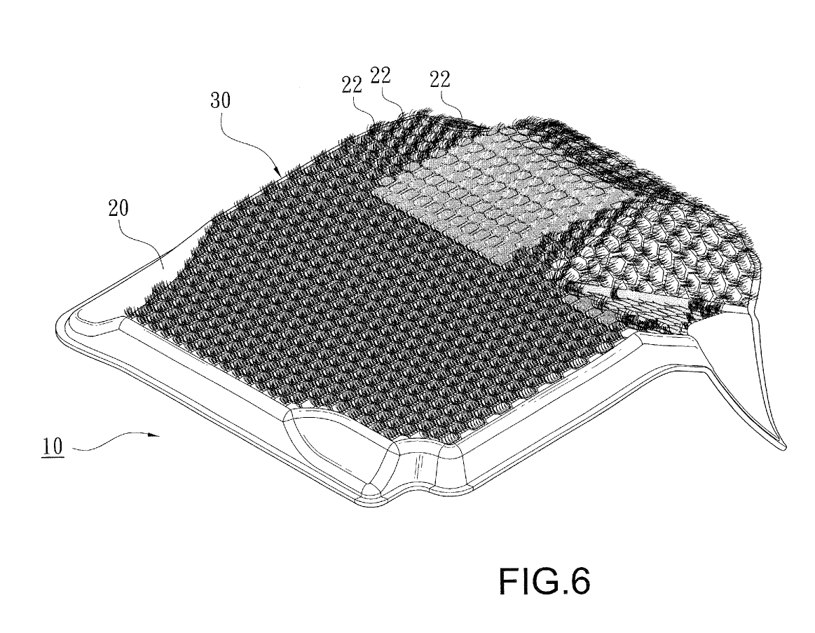

The foot mat 10 of the present invention is made by first forming the foamed substance surface layer 20 and then bonding the bottom anti-skidding layer 30 thereto by applying adhesives or employing thermal fusion molding techniques. Alternatively, a top layer 40 can be prepared first with an adhesive layer applied to a back side thereof and then the foamed substance surface layer 20 is adhesively attached thereto, and the bottom anti-skidding layer 30 is subsequently bonded thereto, which layers are finally secured together through adhesion or thermal fusion molding techniques to thereby form an automobile foot mat 10 as shown in FIG. 5 or FIG. 6.

Thus, the automobile foot mat made in accordance with the present invention has foundation layer that possesses the advantages of light weight, high air permeability, and flexibility and can be used to make a foot mat that shows excellent resistance against skidding and does not have the drawback of damaging an in-car carpet after repeated attaching to and detaching from the carpet.

To summarize, the present invention provides a structure of a foot mat, which, although simple in structure, shows the advantage of being easy for mass production and reduction of manufacturing cost, to provide the features of light weight, sound isolation, sound absorption, and water resistance, and is thus suitable for making an automobile foot mat or an in-car carpet with effectively improved manufacturing efficiency.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An anti-skidding structure adapted for use in an automobile foot mat, wherein the foot mat is composed of an upper surface layer and a bottom anti-skidding layer, characterized in that:
the anti-skidding layer comprises a touch-fastening anti-skidding material, which is formed by collectively knitting synthetic yarns and pliable base yarns in such a way that each of the synthetic yarns is bent to form a U-shaped configuration, having a loop and two outward-extending short legs, each rear loop being set to loop around each front loop so that the loops are linked together with the short legs that are located at ends of the loops having a predetermined length extending outside a foundation layer, the synthetic yarns extending outside a foundation layer formed by collectively knitting the synthetic yarns and the base yarn by a predetermined length, the synthetic yarns showing rigidity strength; and
the surface layer and the anti-skidding material are bonded together by application of adhesives or employing thermal fusion molding techniques.

2. The anti-skidding structure according to claim 1, wherein the surface layer is formed of a foaming substance, which comprises a crosslinked polyethylene (XPE) foamed board.

3. The anti-skidding structure according to claim 1, wherein the surface layer is formed of a foaming substance, which comprises a polyethylene (PE) foamed board.

4. The anti-skidding structure according to claim 1, wherein the surface layer is formed of a foaming substance, which comprises ethylene-vinyl acetate copolymer (EVA).

5. The anti-skidding structure according to claim 1, wherein the surface layer is formed of a foaming substance, which comprises a polyurethane (PU) foamed board.

6. The anti-skidding structure according to claim 1, wherein the surface layer is formed of a carpet material.

7. The anti-skidding structure according to claim 1, wherein the surface layer is formed of thermoplastic elastomer (TPE).

8. The anti-skidding structure according to claim 1, wherein the surface layer is formed of anti-skidding thermoplastic rubber (TPR).

9. The anti-skidding structure according to claim 1, wherein the surface layer is formed of polyvinylchloride (PVC).

10. The anti-skidding structure according to claim 1 further comprising a top layer formed atop the surface layer.

11. (canceled)

12. The anti-skidding structure according to claim 1, wherein the synthetic yarns are made of polypropylene (PP).

13. The anti-skidding structure according to claim 1, wherein the synthetic yarns are made of polyethylene (PE).
